(19) United States
(12) Patent Application Publication
(10) Pub. No.: US 2026/0360351 A1
(43) Pub. Date: Nov. 12, 2026

(54) PROXY METRICS AND SPEECH PERSONALIZATION

(71) Applicant: GDM Holding LLC, Mountain View, CA (US)

(72) Inventors: Pu-sen Chao, Los Altos, CA (US); Zhang Chen, Mountain View, CA (US); Petar Stanisa Aleksic, Hawthorne, NJ (US); Steven Jeffrey Knauer, New York, NY (US); Haozhen Wu, Long Island City, NY (US)

(73) Assignee: GDM Holding LLC, Mountain View, CA (US)

(21) Appl. No.: 19/636,877

(22) Filed: Apr. 1, 2026

Related U.S. Application Data
(60) Provisional application No. 63/803,261, filed on May 9, 2025.

(51) Int. Cl. G10L 13/04; G10L 15/22

(52) U.S. Cl. CPC G10L 13/04; G10L 15/22; G10L 2015/223

(57) ABSTRACT

A method includes monitoring voice-based interactions between a user and a digital assistant and determining, based on the voice-based interactions, one or more proxy metrics for the digital assistant, the one or more proxy metrics uniquely associated with the user. The method also includes adjusting, based on the one or more proxy metrics, one or more operational parameters of the digital assistant for subsequent interactions with the user. After adjusting the one or more operational parameters, the method also includes receiving a query from the user. The method also includes generating, using the digital assistant with the one or more adjusted operational parameters, a response based on the query.

### CROSS-REFERENCE TO RELATED APPLICATIONS

This U.S. Patent Application claims priority under 35 U.S.C. § 119(e) to U.S. Provisional Application 63/803,261, filed on May 9, 2025. The disclosure of this prior application is considered part of the disclosure of this application and is hereby incorporated by reference in its entirety.

### TECHNICAL FIELD

This disclosure relates to proxy metrics and speech personalization.

### BACKGROUND

Digital voice assistants and similar speech processing systems aim to deliver natural and efficient user interactions across a wide range of applications. Evaluating the performance of these systems typically involves collecting extensive user speech data, followed by offline transcription and analysis to establish ground-truth data for assessing accuracy and responsiveness. The evaluation process demands significant computational power, human effort, and time, rendering the approach both costly and slow. Moreover, the optimization of system parameters often results in static, globally-tuned settings designed to accommodate an average user profile. However, users demonstrate a broad spectrum of interaction patterns, influenced by factors such as variations in accent, speech rate, vocabulary, and command phrasing, meaning that a uniform configuration frequently delivers suboptimal experiences for many individuals whose speech characteristics deviate from the norm.

### SUMMARY.

One aspect of the disclosure provides a computer-implemented method that when executed on data processing hardware causes the data processing hardware to perform operations that include monitoring voice-based interactions between a user and a digital assistant and determining, based on the voice-based interactions, one or more proxy metrics for the digital assistant, the one or more proxy metrics uniquely associated with the user. The operations also include adjusting, based on the one or more proxy metrics, one or more operational parameters of the digital assistant for subsequent interactions with the user. The operations also include receiving a query from the user after adjusting the one or more operational parameters and generating, using the digital assistant with the one or more adjusted operational parameters, a response based on the query.

Implementations of the disclosure may include one or more of the following optional features. In some implementations, adjusting the one or more operational parameters includes selecting a pre-defined operational configuration from a plurality of pre-defined operational configurations of the digital assistant, while each respective pre-defined operational configuration specifies corresponding values for the one or more operational parameters. Determining the one or more proxy metrics may include determining the one or more proxy metrics without analyzing transcriptions derived from user speech from the voice-based interactions. Optionally, monitoring the voice-based interactions may include receiving user feedback associated with interaction pacing of the digital assistant or interruptions by the digital assistant.

In some examples, adjusting the one or more operational parameters includes modifying an endpointing parameter of the digital assistant for the user based on the one or more proxy metrics, while the endpointing parameter influences when the digital assistant transitions from a first level of automatic speech recognition (ASR) processing to a second level of ASR processing. In these examples, the one or more proxy metrics may include a barge-in timing metric indicating a time duration between an initiation of a text-to-speech (TTS) output by the digital assistant and a subsequent user input detected during the TTS outputs. The one or more proxy metrics may optionally include a speech rate metric indicating an estimated rate of speech of the user during the voice-based interactions.

In some implementations, adjusting the one or more operational parameters includes modifying a TTS operational parameter of the digital assistant for the users based on the one or more proxy metrics. In these implementations, the TTS operational parameter may include a TTS playback speed influencing a rate of speed that the digital assistant outputs the TTS output. Optionally, the TTS operational parameter may include a verbosity level influencing a length or level of detail of the TTS output.

Another aspect of the disclosure provides a system including data processing hardware and memory hardware in communication with the data processing hardware and storing instructions that when executed on the data processing hardware causes the data processing hardware to perform operations. The operations include monitoring voice-based interactions between a user and a digital assistant and determining, based on the voice-based interactions, one or more proxy metrics for the digital assistant, the one or more proxy metrics uniquely associated with the user. The operations also include adjusting, based on the one or more proxy metrics, one or more operational parameters of the digital assistant for subsequent interactions with the user. The operations also include receiving a query from the user after adjusting the one or more operational parameters and generating, using the digital assistant with the one or more adjusted operational parameters, a response based on the query.

This aspect of the disclosure may include one or more of the following optional features. In some implementations, adjusting the one or more operational parameters includes selecting a pre-defined operational configuration from a plurality of pre-defined operational configurations of the digital assistant, while each respective pre-defined operational configuration specifies corresponding values for the one or more operational parameters. Determining the one or more proxy metrics may include determining the one or more proxy metrics without analyzing transcriptions derived from user speech from the voice-based interactions. Optionally, monitoring the voice-based interactions may include receiving user feedback associated with interaction pacing of the digital assistant or interruptions by the digital assistant.

In some examples, adjusting the one or more operational parameters includes modifying an endpointing parameter of the digital assistant for the user based on the one or more proxy metrics, while the endpointing parameter influences when the digital assistant transitions from a first level of automatic speech recognition (ASR) processing to a second level of ASR processing. In these examples, the one or more proxy metrics may include a barge-in timing metric indicating a time duration between an initiation of a text-to-speech (TTS) output by the digital assistant and a subsequent user input detected during the TTS outputs. The one or more proxy metrics may optionally include a speech rate metric indicating an estimated rate of speech of the user during the voice-based interactions.

In some implementations, adjusting the one or more operational parameters includes modifying a TTS operational parameter of the digital assistant for the users based on the one or more proxy metrics. In these implementations, the TTS operational parameter may include a TTS playback speed influencing a rate of speed that the digital assistant outputs the TTS output. Optionally, the TTS operational parameter may include a verbosity level influencing a length or level of detail of the TTS output.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system using a conversational assistant application to personalize a digital assistant based on proxy metrics.

FIG. 2 is a schematic view of an example automatic speech recognition system of the conversational assistant application.

FIG. 3 includes a flowchart of an example arrangement of operations for a computer-implemented method of using proxy metrics for speech personalization.

FIG. 4 is a schematic view of an example computing device that may be used to implement the systems and methods described herein.

Like reference symbols in the various drawings indicate like elements.

### DETAILED DESCRIPTION

Conversational systems, including digital voice assistants and chatbots, often utilize large language models (LLMs) to understand and respond to user requests expressed through natural language, particularly spoken language. Conversational systems aim to provide seamless and intuitive interfaces, enabling users to perform complex tasks, access information, and control devices by speaking. Processing user interactions involves multiple stages for interpreting user input accurately and generating relevant responses.

Automatic speech recognition (ASR) quality is often measured by accuracy (e.g., low word error rate) and latency to ensure system responsiveness. Endpointing, a factor influencing perceived latency, is defined as the process of detecting precisely when a user has finished speaking a query or command. Accurate endpointing allows for finalization of the transcription and prompt progression to response generation. However, determining appropriate endpointing parameters is challenging. Configuring endpointing too aggressively may cut off the user mid utterance, leading to incomplete queries and user frustration. Conversely, configuring endpointing too conservatively introduces unnecessary delays before the system responds. Current systems often employ static endpointing thresholds that do not effectively accommodate variations in user speech patterns and pauses.

Similarly, the characteristics of text-to-speech output significantly affect interaction quality. Synthesized speech is expected by users to sound natural while also being appropriately paced and concise for the context. Perceiving a TTS response as too slow or excessively verbose may cause users to interrupt the system (e.g., barge in) to expedite interaction or provide subsequent input. Conversely, a TTS response that is too fast or overly terse may be difficult to follow or lack necessary detail. Optimization of TTS response speed and verbosity often involves compromises, as user preferences for response style differ substantially.

The optimization of such parameters (e.g., endpointing thresholds, TTS speed, TTS verbosity, etc.) is typically performed based on aggregated data reflecting average user behavior. Such optimization results in static system configurations which remain unchanged across different users and interactions. However, individuals exhibit significant variability in individual conversational styles, including differences in speaking rate, pause durations between phrases, tolerance for system delays, and preferences regarding response length. Consequently, a system tuned for an average user may frequently feel unnatural, unresponsive, or inefficient for individuals whose interaction patterns deviate from the norm, resulting in interaction friction and reduced user satisfaction.

Accordingly, implementations herein are directed towards personalizing a digital assistant based on proxy metrics. A conversational assistant application determines the proxy metrics based on voice-based interactions between a user and the digital assistant. Notably, the proxy metrics are determined without analyzing transcriptions derived from user speech from the voice-based interactions. The conversational assistant application adjusts one or more operational parameters of the digital assistant for subsequent interactions with the user based on the one or more proxy metrics. Thereafter, the digital assistant receives a query and generates a response based on the query with the one or more adjusted operational parameters.

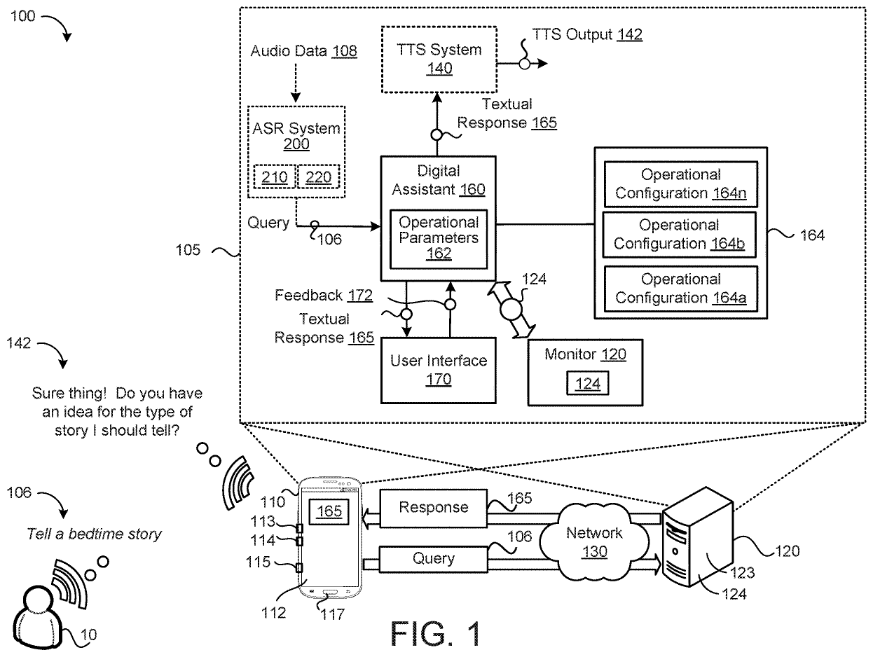

FIG. 1 illustrates an example system 100 for allowing a spoken conversation between a user 102 and a digital assistant 160. The digital assistant 160 may employ a sequence processing neural network model. In some examples, the sequence processing neural network includes a large language model (LLM). For simplicity, the present disclosure will refer to the sequence processing neural network model as an LLM, however, the sequence processing neural network model may include other types of sequence processing neural network models other than LLMs without departing from the scope of the present disclosure. A conversational assistant application 105 may execute on a user device 110 associated with the user 102 to enable the user 102 and the digital assistant 160 to interact with one another through spoken conversation.

The conversational assistant application 105 may access various components for facilitating the spoken conversation in a natural manner between the user 102 and the digital assistant 160. For instance, in some implementations, the digital assistant 160 interacts with the user 102 via separate speech processing components. Using application programming interfaces (APIs) or other types of plug-ins, the conversation assistant application 105 may access an optional automatic speech recognition (ASR) system 200 to convert spoken input into text, and an optional text-to-speech (TTS) system 140 to convert the textual response 165 of the digital 160 into spoken output. These systems (e.g., the ASR system 200 and the TTS system 140), along with a user interface 170, may be accessed by the conversational assistant application 105. Alternatively, in other implementations, the digital assistant 160 itself includes a multimodal LLM architecture that directly processes spoken input (e.g., performing ASR functions internally) and/or directly generates spoken output (e.g., performing TTS functions internally). In such cases, the digital assistant 160 handles the speech-to-text and text-to-speech conversions without necessarily relying on distinct, separate ASR systems 200 and TTS 140 systems.

During a user turn of the spoken conversation between the user 102 and the digital assistant (or simply “assistant”) 160, the user device 110 captures audio data 108 characterizing an utterance of a natural language query 106 spoken by the user 102 and directed toward the assistant 160 to solicit a textual response 165 from the assistant 160. For instance, the query 106 may specify a particular task that the user 102 would like the assistant to perform, or may specify a particular question that the user 102 would like the assistant 160 to answer and the digital assistant 160 may generate a textual response 165 that answers the question. The query 106 may similarly correspond to a request for information and the assistant 160 may generate a textual response 165 conveying the requested information. While the term query 106 is used, the query 106 may correspond to any natural language dialog (e.g., a greeting) directed toward the digital assistant 160 during the user turn in the spoken conversation between the user 102 and the digital assistant 160. The user 102 may speak the utterance of the query 106 in natural language and the ASR system 200 may perform speech recognition on the audio data 108 characterizing the utterance of the query 106 to generate a textual representation of the query 106 spoken by the user 102. Thereafter, the ASR system 200 feeds the textual representation of the query 106 to the digital assistant 160 to enable the digital assistant 160 to perform the task and generate the textual response 165 to the query 106. In implementations where the digital assistant 160 integrates ASR capabilities, the assistant 160 may process the audio data 108 directly to determine the textual representation of the query 106. The digital assistant 160 may send the textual response 165 to the user interface 170 such that the textual response 165 is visually displayed to the user 10 via a screen 112 of the user device 110.

The TTS system 140 receives the textual response 165 from the digital assistant 160 and generates the corresponding spoken audio (TTS output 142). The process for generating the TTS output 142 may involve multiple stages. First, a text processing or normalization stage cleans and prepares the textual response 165, for instance, by expanding abbreviations, converting numerals into their word equivalents, and handling punctuation appropriately. Next, linguistic features are extracted or predicted from the processed text. The extracted features may include phonetic transcriptions (sequences of phonemes) and prosodic information defining the intended rhythm, intonation, and stress of the speech. Based on these linguistic features, an acoustic model generates an intermediate representation of the speech signal, commonly a sequence of acoustic frames such as a mel-spectrogram. Finally, a vocoder synthesizes the audible time-domain waveform, which constitutes the TTS output 142, from the intermediate acoustic representation. In implementations where the digital assistant 160 integrates TTS capabilities directly, as mentioned previously, these stages (text processing, linguistic feature extraction, and acoustic modeling) may be performed internally by the digital assistant 160 while a vocoder (not shown) is leveraged to synthesize the audible time-domain waveform from the sequence of acoustic frames to produce the TTS output 142.

The system includes the user device 110, a remote computing system 120, and a network 130. The user device 110 includes data processing hardware 113 and memory hardware 114. The user device 110 may include, or be in communication with, an audio capture device 117 (e.g., an array of one or more microphones) for converting utterances of natural language queries 106 spoken by the user 10 into corresponding audio data 108. In scenarios when the user 102 speaks a natural language query 106 captured by the microphone 117 of the user device 110, the ASR system 200 executing on the user device 110 or the remote computing system 120 may process the corresponding audio data 108 to generate a transcription (e.g., speech recognition result) of the query 106. Here, the transcription conveys the query 106 provided as input to the digital assistant 160. The ASR system 200 may include a speech recognition model 210. The ASR system 200 may optionally implement an endpointer model 220. Even in implementations where the digital assistant 160 performs ASR functions internally, the concepts of speech recognition and endpointing remain relevant to how the assistant 160 processes the audio data 108.

The microphone 117 of the user device 110 may remain always-on or open during the conversation between the user 102 and the digital assistant 160 to permit the conversational application to always accept speech spoken by the user 102, thereby providing a more natural dialog between the user 102 and the digital assistant 160. As will become apparent, the digital assistant 160 may employ different levels of ASR processing while the microphone 117 is always on. For instance, the user 102 may barge-in through speech directed toward the digital assistant 160 even during times when the conversational application 105 is audibly outputting the TTS output 142. That is, a barge-in refers to a scenario where the user 10 starts speaking before the assistant 160 has finished outputting the TTS output 142. Moreover, the barge-in may refer to a scenario where the user 10 starts speaking shortly after the digital assistant 160 determined that the user 10 was done speaking (e.g., end of query detection). Detecting a barge-in event typically involves monitoring the microphone input for user speech energy while the digital assistant 160 is outputting the TTS output 142. In implementations utilizing a separate TTS system 140, the TTS output 142 occurs from an audio output device (e.g., speaker) 115 of the user device 110, as text-to-speech audio generated by the TTS system 140 based on a textual response 165 from the digital assistant 160. In implementations where the digital assistant 160 integrates TTS capabilities, the assistant 160 may directly generate the output audio signal representing the textual response 165, which is then played through the audio output device 115.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., cloud computing environment) having scalable elastic resources. The resources includes computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

The conversation assistant application 105 employs a monitor 120 that monitors voice-based interactions 122 between the user 102 and the digital assistant 160. The voice-based interactions 122 include the queries 106 provided by the user 102, textual responses 165 and TTS outputs 142 provided by the digital assistant 160, and any subsequent queries provided by the user 102 after or during output of the textual response 165 or the TTS output 142. Notably, the monitoring performed by the monitor 120 focuses on the dynamics of the conversation, such as timing, pauses, and overlaps, of the queries 106 provided by the user 10 and the outputs (e.g., textual response 165 and TTS output 142) from the digital assistant 160 rather than necessarily the semantic content. In some implementations, monitoring the voice-based interactions 122 includes receiving user feedback 172 associated with interaction pacing of the digital assistant 160 or interruptions by the digital assistant 160. The user feedback 172 may be explicit (e.g., verbal commands like “speed up” or ratings provided via the user interface 170) or implicit (e.g., analyzing patterns of barge-ins as feedback on pacing or verbosity).

The monitor 120 determines one or more proxy metrics 125 for the digital assistant 160 based on observed patterns within the voice-based interactions 122 and/or received user feedback 172. Proxy metrics 125 provide indirect indications of underlying interaction quality or user state (e.g., satisfaction, impatience) derived from measurable aspects of interaction behavior. The proxy metrics 125 serve as indicators of interaction quality and user experience for specific aspects of the conversation flow, regardless of whether the ASR/TTS functions are handled by separate systems (e.g., ASR system 200, TTS system 140) or integrated within the assistant 160. As will become apparent, the proxy metrics 125 may subsequently inform adjustments to various operational parameters 162 governing interaction flow, for example, parameters associated with speech input processing and speech output generation. Notably, the proxy metrics 125 are uniquely associated with the user 10 such that adjustments of the digital assistant 160 are specific to each user 10.

The digital assistant 160 may include one or more operational parameters 162 related to speech input processing and TTS output generation. While the operational parameters 162 are shown as part of the digital assistant 160, the operational parameters 162 may also be associated with the ASR system 200 and the TTS system 140 when these components are employed. The operational parameters 162 related to speech input processing may include an endpointing parameter. The endpointing parameter influences the determination of when the digital assistant 160 transitions from a first level of ASR processing to a second level of ASR processing. Endpointing, the determination of when a user 102 has finished speaking, influences how the assistant 160 processes the audio data 108. Moreover, the system may operate the ASR system 200 (or the integrated ASR capabilities of the assistant 160) using distinct levels of processing depending on the conversational turn. Specifically, the digital assistant 160 may employ a first level of ASR processing when user speech is anticipated, for example, immediately after the assistant 160 finishes speaking (e.g., following a text-to-speech (TTS) end event). The first level is optimized for high accuracy and sensitivity to reliably capture the natural language query 106. Conversely, the digital assistant 160 may employ a second level of ASR processing while the assistant 160 is actively outputting speech (e.g., during TTS audio 174 playback). The second level is configured with reduced sensitivity or different processing characteristics compared to the first level. The primary goal of the second level during assistant 160 output is to reliably detect user attempts to interrupt or “barge-in” while minimizing the risk of misinterpreting the speech output by the assistant 160 or background noise as user input, thereby using fewer computational resources. To that end, the endpointing parameter influences when the digital assistant 160 transitions from this first level of ASR processing to the second level of ASR processing, or vice versa, based on speech detection and timing.

Based on the proxy metrics 125 derived from the interaction patterns of the user 102, the application 105 may modify the operational parameters 162 of the digital assistant 160. For example, adjusting the one or more operational parameters 162 may include modifying the endpointing parameter of the digital assistant 160 for the user 102 based on the one or more proxy metrics 125. Adjusting the endpointing parameter may influence when the system determines the user 102 has finished speaking, which may trigger the digital assistant 160 to begin processing the recognized speech 146. For instance, for a user 10 whereby the proxy metrics 125 indicate the user 10 often barges-in, the endpointing parameter may delay the time that the digital assistant 160 determines that the user 102 has finished speaking, and thus, extend the time that the digital assistant 160 employs the first level of ASR processing after the user 10 has finished speaking. However, the state of the speech output by the assistant 160 controls the switch between the first level of ASR processing and the second level of ASR processing. Proxy metrics 125 may inform adjustments to endpointing parameters and potentially influence the specific characteristics or thresholds employed within each ASR processing level, thereby adapting the balance between responsiveness, accuracy, and barge-in robustness based on inferred user 102 needs or interaction style.

The assistant 160 may implement the differentiation between the first and second levels of ASR processing in various ways. For example, the first level (high sensitivity, for user turns) may involve setting a lower confidence threshold for recognizing speech tokens, employing multi-pass processing (e.g., an initial streaming pass followed by a more complex non-streaming rescoring pass), using bidirectional processing for greater context, or utilizing a wider beam search during decoding to consider more candidate transcriptions. The second level (lower sensitivity, during assistant turns) may involve setting a higher confidence threshold, using only a single-pass, unidirectional ASR model (e.g., a streaming model), employing a narrower beam search, or even using a simpler, faster ASR model optimized primarily for detecting speech presence or specific barge-in keywords rather than full transcription. By switching between the levels, the digital assistant 160 maintains high recognition accuracy when the user 102 is expected to speak, while reducing computational load and false positives when the digital assistant 160 is speaking but the microphone 113 remains open to allow for barge-in.

The monitor 120 may determine various proxy metrics 125 from the voice-based interactions 122. For example, a proxy metric 125 for endpointing performance may involve detecting if the user 102 resumes speaking very shortly after the system (whether the ASR system 200 or the integrated assistant 160) determines an endpoint for a previous utterance. A very short time gap between the system-detected endpoint and the user 102 starting to speak again serves as a proxy indicating that the endpointing parameter settings may be too aggressive for that user 102, thereby cutting off the user 102 mid-thought or before the user 102 had naturally paused. Another example of a proxy metric includes a barge-in timing metric. A barge-in timing metric provides another proxy metric 125, particularly relevant for gauging user patience or perception of TTS output 142 speed or verbosity level (e.g., length or level of detail of the TTS output 142). The barge-in timing metric specifically measures the time duration that elapses between the moment the digital assistant 160 initiates the TTS output 142 and the moment digital assistant 160 detects a subsequent user input (e.g., the user 102 starting to speak again, constituting a barge-in) while that TTS output 142 is still ongoing. The barge-in timing metric serves as an indicator potentially related to user perception of the response speed or verbosity of the TTS output 142. Explicit user feedback regarding pacing (e.g., “you talk too fast”) or interruptions (e.g., “stop interrupting me”) can also be directly processed as, or contribute to, proxy metrics 125 indicating desired adjustments.

In some examples, shorter durations measured by the barge-in timing metric suggests the user 102 perceives the response as too slow or overly verbose. Moreover, a speech rate metric may serve as a proxy metric 125. The speech rate metric metric involves estimating the rate of speech (e.g., words per minute or syllables per second) of the user 102 during the voice-based interactions 122 with the assistant 160. The estimated rate of speech provides insights into the natural speaking pace of the user 102 or potential state (e.g., urgency), which may inform adjustments to timing or response style of the digital assistant 160. The proxy metrics 125, such as the barge-in timing metric and the speech rate metric, provide quantitative insights into the interaction style and state of the user 102, which can then be used to inform the adjustment of operational parameters 162, like the endpointing parameter influencing ASR processing levels, or parameters controlling TTS output characteristics. Notably, the monitor 120 may determine the one or more proxy metrics 125, such as those based purely on timing (e.g., the barge-in timing metric) and speech detection characteristics (e.g., detection of speech resumption after endpointing, or acoustic features used for speech rate estimation), without analyzing the actual content or transcriptions derived from user speech from the voice-based interactions, potentially enhancing privacy and reducing computational load. Even when processing explicit user feedback 172 related to pacing or interruption, the digital assistant may identify keywords or feedback intent without requiring full semantic analysis or storage of the feedback transcription itself, thus preserving the characteristic of determining proxy metrics 125 without analyzing transcriptions derived from user speech.

The one or more proxy metrics 124 are uniquely associated with the user 102, thereby capturing the individual interaction style and preferences of the user 102 over time. The conversational assistant application 105 then utilizes the user-specific proxy metrics 125 to personalize the interaction by adjusting one or more operational parameters of the digital assistant 160 and/or associated components (e.g., the ASR system 200 or TTS system 140) for subsequent interactions with the user 102 based on the one or more proxy metrics 125. For instance, if the proxy metrics 125 indicate frequent premature endpointing for the user 102 (e.g., high rate of immediate barge-ins), the application 105 may adjust endpointing parameters(such as the required silence duration before finalizing an utterance) either within the ASR system 200 or as parameters controlling the endpointing logic within an integrated digital assistant 160 for that user 102. Consequently, after adjusting the one or more operational parameters, when the digital assistant 160 subsequently receives a query 106 from the particular user 102, the endpointing logic operates according to the adjusted operational parameters 162 during the processing of the query 106, and the digital assistant 160 generates a textual response 165 using the adjusted operational parameters 162.

Similarly, if the proxy metrics 125, such as a pattern of frequent and early barge-ins (e.g., short barge-in timing metrics), indicate user impatience or dissatisfaction with the presentation style during playback of the TTS output 142, the application 105 may adjust one or more TTS operational parameters 162 for the user 102. For example, the application 105 may modify a TTS playback speed parameter, influencing the rate of speed at which the digital assistant 160 outputs the TTS output 142, which may increase the speed for users 102 who frequently barge-in early. Alternatively, or in addition, the application 105 may adjust a verbosity level parameter. The verbosity level parameter influences the length or level of detail of the TTS output 142. Based on proxy metrics 125 suggesting impatience or perhaps preference for brevity (e.g., consistent early barge-ins), the application 105 may select a lower verbosity level operational parameter 162, resulting in more concise responses. Conversely, if the proxy metrics 125 suggest that the user 102 rarely barges in or exhibits a slower interaction pace, the application 105 may adjust TTS operational parameters 162 for slower playback and/or a higher verbosity level offering more detailed responses. Following such adjustments, when the digital assistant 160 generates a textual response 165 based on a subsequent query 106 from the user 102, the TTS system 140 (or integrated TTS function of the digital assistant 160) utilizes the adjusted playback speed and/or verbosity level parameters to synthesize the spoken output.

Moreover, the estimated speech rate metric may directly inform operational parameter 162 adjustments. For example, if the estimated speech rate for the user 102 is consistently high, suggesting urgency or a preference for faster interaction, the conversational assistant application 105 may adjust the endpointing parameter to be more aggressive, potentially shortening the required silence duration before finalizing an utterance or accelerating the transition between ASR processing levels. Conversely, a consistently slower estimated speech rate may lead the application 105 to adjust the endpointing parameter to be less aggressive, allowing for longer pauses without prematurely triggering the end of the user turn or delaying the transition between ASR processing levels to accommodate potentially longer, more thoughtful phrasing. In some instances, the speech rate metric also influences TTS operational parameters 162, such as adjusting the output speed of the TTS output 142 to better align with the speaking pace of the user 102. The speech rate metric may also directly influence TTS operational parameters 162. For instance, a consistently high user speech rate may lead the application 105 not only to adjust endpointing but also to increase the TTS playback speed parameter, aiming to match the preferred pace of the user 102. Conversely, a slower user speech rate may suggest adjusting the TTS playback speed parameter to a slower setting. The examples described related to adjusting the operational parameters 162 of the digital assistant 160 are non-limiting. Thus, it is understood that, when the ASR system 200 and the TTS system 140 are leveraged, the operational parameters 162 may be associated with the ASR system 200 and/or the TTS system 140 and be adjusted accordingly.

In some examples, the conversational assistant application 105 adjusts the one or more operational parameters 162 by selecting a pre-defined operational configuration 164 from a plurality of pre-defined operational configurations 164, 164a-n of the digital assistant 160. Each pre-defined operational configuration represents a distinct interaction profile or mode for the digital assistant 160. For example, there may be pre-defined operational configurations 164 corresponding to a “patient” user 102 (e.g., using longer silence thresholds for endpointing, slower TTS speech), a “standard” user 102, and an “impatient” user (e.g., using shorter silence thresholds, faster TTS speech, favoring conciseness). Here, each respective pre-defined operational configuration 164 specifies corresponding values for the one or more operational parameters 162 (e.g., specific endpointing thresholds, TTS playback speed value, TTS verbosity level setting). When personalization is triggered based on the user-specific proxy metrics 125, the conversational assistant application 105 selects one of these existing, pre-defined operational configurations 164 that is deemed most appropriate for the observed interaction style of the user 102. For example, if proxy metrics 125 suggest user impatience, a pre-defined operational configuration 164 with faster timing parameters and optionally lower verbosity settings may be selected and applied for subsequent interactions with that user 102. Thereafter, when the digital assistant 160 receives a query 106 from the user 102, the digital assistant 160 will operate using the operational parameters 162 defined by the selected pre-defined configuration 164 to process the query 106 and generate the textual response 165.

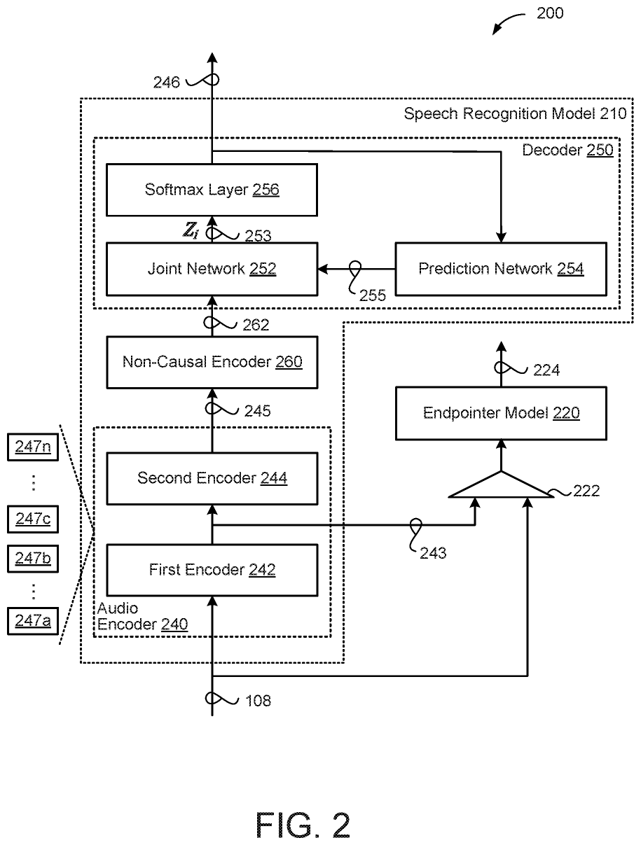

Referring now to FIG. 2, in some implementations, the ASR system 200 is capable of performing multiple tasks of speech recognition, endpointing, voice activity detection (VAD), and end of query (EOQ) detection. As shown, the ASR system 200 includes and integrates together the speech recognition model 210, the endpointer model 220, and the switch connection 222 of the ASR system 200 and may be jointly trained, deployed, and maintained. As described herein, the user device 110 executes the ASR system 200. However, it is understood that the remote computing system 120 may also perform one or more portions, or all, of the ASR system 200 in addition to, or in lieu of, the user device 110.

In the example shown, the speech recognition model 210 includes a streaming, cascaded conformer-transducer (Conf-T) architecture including an audio encoder 240, and a decoder 250. Here, the audio encoder 240 includes a cascading causal encoder architecture having a first encoder 242 and a second encoder 244. The cascading audio encoder 240 refers to a model structure where the encoding pathway includes the two encoder 242, 244 that cascade such that the output of the first encoder 242 feeds the input of the second encoder 244 prior to decoding.

The first encoder 242 receives or obtains a sequence of d-dimensional feature vectors (e.g., audio data 108 (FIG. 1)) x=(x₁, x₂, . . . , x_{T}), where xₜ ∈ [symbol] _{d}, and encodes the audio data 108 into corresponding latent representations 243 as outputs of a final layer of the first encoder 242. The second encoder 244 is connected in cascade to the first encoder 242, and is trained to receive the latent representations 243 as inputs, and encode the latent representations 243 into corresponding first higher-order feature representations 245 as outputs of a final layer of the second encoder 244. This first higher-order feature representation 245 is denoted as

$${h}_{1}^{enc} , … , {h}_{T}^{enc} .$$

Here, each audio frame includes a 128-dim log-mel feature vector computed for a 32 millisecond window every 10 milliseconds and stacked with three previous feature vectors to produce a 512-dim audio frame. In some examples, the speech recognition model 210 also includes a non-causal encoder 260 configured to receive as input the first higher order feature representations 245 and generate as output corresponding second higher-order feature representations 262 for the first higher-order feature representations 245.

In some implementations, the cascading audio encoder 240 includes a stack of a plurality (e.g., seven) of multi-head (e.g., eight headed) attention layers 247, 247a-n (e.g., conformer or transformer layers), with the first encoder 242 including an initial stack of layers 247a-b (e.g., two) from the stack of the plurality of layers 247 with an attention dimension of 512, and the second encoder 244 including a time-reduction stacking layer that down samples its input by a factor of two followed by another multi-head attention layer 247c from the stack of the plurality of multi-head attention layers 247, a projection layer, and the rest of the multi-head attention layers 247d-n from the stack of the plurality of multi-head attention layers 247. Here, causal convolution and left-context attention layers may be used for each layer to strictly restrict the audio encoder 240 to use no future inputs. The first encoder 242 may be referred to as a causal encoder and the second encoder 244 may be referred to as a non-causal encoder.

The endpointer model 220 is configured to operate between a VAD mode and an EOQ detection mode. While the endpointer model 220 is operating in the VAD mode, the switch connection 222 provides the audio data 108 to the endpointer model 220, and the endpointer model 220 performs VAD based on the audio frames 144. When the endpointer model 220 is operating in the VAD mode, which occurs prior to starting speech recognition, the speech recognition model 210 (including the shared first encoder 242) is not, or does not need to be, activated (i.e., audio data 108 does not need to be sent to or processed by the speech recognition model 210) because the endpointer model 220 is performing VAD based on the audio data 108. In the VAD mode, the endpointer model 220 outputs, for each frame of the audio data 108, an endpoint label 224 that indicates whether or not the audio frame includes speech. During the VAD mode, the endpointer model 220 selects each endpoint label 224 to be initial silence (i.e., silence before the start of an utterance) or speech. Here, the ASR system 200 may determine whether or not an audio frame of the audio data 108 includes speech by comparing a speech present prediction probability to a pre-determined probability threshold.

When the endpointer model 220 determines that one or more audio frames in the audio data 108 include speech and outputs one or more endpoint labels 224 of speech, the ASR system 200 activates the speech recognition model 210 so that the speech recognition model 210 begins performing speech recognition on a sequence of audio frames 144, configures the switch connection 222 to provide latent representations 243 for the sequence of audio frames 144 generated by a shared portion of the audio encoder 240 (i.e., the first encoder 242) to the endpointer model 220, and switches operation of the endpointer model 220 from the VAD mode to the EOQ detection mode. In the EOQ detection mode, the endpointer model 220 determines, for each latent representation 243, whether or not the latent representation 243 includes a final silence representing that an EOQ event has occurred or includes an intermediate silence, and outputs a corresponding endpoint label 224 of final silence or intermediate silence. Here, the endpointer model 220 selects each endpoint label 224 to be speech, intermediate silence (e.g., silence in the middle of an utterance), or final silence (e.g., after the end of an utterance). Here, the endpointer model 220 may determine whether or not an audio frame includes speech by comparing a speech present prediction probability to a pre-determined probability threshold. Notably, the pre-determined probability threshold for the EOQ detection mode may be different from the pre-determined probability threshold for the VAD mode.

While the endpointer model 220 is operating in the EOQ detection mode, the switch connection 222 provides latent representations 243 output from a final layer 247b of the shared layers 247a-b (i.e., the first encoder 242) to the endpointer model 220, and the endpointer model 220 performs EOQ detection based on the latent representations 243. Thus, in the EOQ detection mode, the endpointer model 220 takes can take advantage of, or leverage, the latent representations 243 already being generated by the audio encoder 240 for speech recognition purposes to improve EOQ detection performance without increasing computational complexity. That is, because the EOQ detection mode is only active during speech recognition, during which the audio encoder 240 is active for speech recognition purposes, EOQ detection performance may be improved by being based on the latent representations 243 already being generated by the audio encoder 240 without increasing computational complexity.

In the example shown, while operating in the EOQ detection mode, the endpointer model 220 shares one or more layers 247a-b with the audio encoder 240 of the speech recognition model 210. Here, the endpointer model 220 shares the first encoder 242 with the audio encoder 240, the first encoder 242 represents an initial stack of multi-head attention layers 247a-b (e.g., conformer or transformer layers) of a stack 246 of a plurality of multi-head attention layers 247a-n that form the audio encoder 240, and the latent representations 243 are output by a final layer 247b of the initial stack of layers 247a-b of the first encoder 242. In some implementations, the endpointer model 220 and the audio encoder 240 share layers using hard parameter sharing. Notably, the speech recognition model 210 and the endpointer model 220 may be jointly trained. By integrating and jointly training the speech recognition model 210 and the endpointer model 220, VAD and EOQ detection performance is improved, as joint training forces the speech recognition model 210 and the endpointer model 220 to learn representations that generalize well across related tasks. When the endpointer model 220, while operating in the EOQ detection mode, determines that one or more latent representations 243 include a final silence and outputs an endpoint label 224 of final silence, the E2E multitask model 200 switches operation of the endpointer model 220 from the EOQ detection mode to the VAD mode, configures the switch connection 222 to provide input audio frames 144 to the endpointer model 220, and disables the speech recognition model 210.

In some implementations, when the endpointer model 220, while operating in the EOQ detection mode, determines that one or more latent representations 243 include an intermediate silence and outputs an endpoint label 224 of intermediate silence, the E2E multitask model 200 temporarily switches operation of the endpointer model 220 from the EOQ detection mode to the VAD mode, configures the switch connection 222 to provide input audio frames 144 to the endpointer model 220, and temporarily disables the speech recognition model 210. When speech continues (e.g., when the endpointer model 220 operating in VAD mode detects speech), the E2E multitask model 200 reverts the endpointer model 220 back to EOQ detection mode and resumes speech recognition by the speech recognition model 210. In this way, the speech recognition model 210 does not need to operate during intermediate silences. In some implementations, the endpointer model 220 includes a stack of LSTM layers followed by a fully-connected layer having a Softmax function configured to predict a probability distribution over possible endpointing labels of speech, initial silence, an intermediate silence, and final silence.

In the example shown, the decoder 250 includes an RNN-T architecture having a joint network 252, a prediction network 254, and a Softmax layer 256. The decoder 250 uses the joint network 252 to combine the first higher-order feature representation 245 and/or the second higher-order feature representation 262 with dense or hidden representations 255 output from the prediction network 254 for previous prediction outputs 257 by the Softmax layer 256 to produce prediction outputs 257. In the example shown, the decoder 250 includes the Softmax layer 256. Alternatively, the Softmax layer 256 may be implemented separately.

In the example shown, the prediction network 254 processes sequence of non-blank symbols 257 (i.e., prediction outputs) output by the final Softmax layer 256 so far, y₀, . . . , yᵤᵢ₋₁, into a dense or hidden representation pᵤ_{ᵢ}, 255. In some implementations, the dense representation pu, 255 includes a single embedding vector. Notably, the sequence of past non-blank symbols 257 received at the prediction network 254 capture linguistic dependencies between non-blank symbols 257 predicted during the previous time steps so far to assist the joint network 252 in predicting the probability of a next output symbol or blank symbol during the current time step. To contribute to techniques for reducing the size of the prediction network 254 without sacrificing accuracy/performance of the decoder 250, the prediction network 254 may receive a limited-history sequence of non-blank symbols 257 yᵤᵢ₋ₙ, . . . , yᵤᵢ₋₁ that is limited to the N previous non-blank symbols 257 output by the final Softmax layer 256.

In the example shown, the joint network 252 combines the first higher-order feature representation 245 produced by the audio encoder 240 and/or the second higher-order feature representation 262 produced by the non-causal encoder 260, and the dense representation pᵤ_{ᵢ} 255 produced by the prediction network 254. The joint network 252 predicts a probability distribution Z_i=P(y_i ┤|x_(t_i), y_0, . . . , y_(u_(i−1)) 253 over the next output symbol. Stated differently, the joint network 252 generates, at each time step, a probability distribution 253 over possible speech recognition hypotheses.

Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 252 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 252 can include a posterior probability value for each of the different output labels. Thus, if there are 100 different output labels representing different graphemes or other symbols, the output Zᵢ 253 of the joint network 252 can include 100 different probability values, one for each output label. The probability distribution can then be used to select and assign scores to candidate orthographic elements (e.g., graphemes, wordpieces, and/or words) in a beam search process (e.g., by the Softmax layer 256) for determining the transcription.

In the example shown, the final Softmax layer 256 receives the probability distribution Zᵢ 253 and selects the output label/symbol with the highest probability to produce the transcription 146. The final Softmax layer 256 may employ any technique to select the output label/symbol with the highest probability in the distribution Zᵢ 253. In this manner, the decoder 250 does not make a conditional independence assumption, rather the prediction of each symbol yᵤ 257 is conditioned not only on the acoustics but also on the sequence of labels 257 yᵤᵢ₋ₙ, . . . , yᵤᵢ₋₁ output so far. The decoder 250 does assume an output symbol 257 is independent of future acoustic frames 144, which allows the speech recognition model 210 to be employed in a streaming fashion.

In some implementations, the prediction network 254 includes a V2 embedding look up table that includes an embedding prediction network. At each time step, the V2 embedding lookup table may receive, as input, the previous two predictions (e.g., 1-hot vectors) output by the joint network 252, compute a respective embedding d₁, d₂ for each of the previous two predictions, and provide a concatenated output [d₁, d₂] to the joint network 252. Alternatively, the prediction network 254 may include one or more conformer or transformer layers. Alternatively, the prediction network 254 may be a long short-term memory (LSTM)-based prediction network including one or more LSTM layers, each of which is followed by a projection layer as well as an embedding layer. In some implementations, the joint network 252 includes one or more neural network layers each having a plurality of hidden units, and the Softmax layer 256 is composed of a unified word piece or grapheme set that is generated using all unique word pieces or graphemes in a plurality of training data sets.

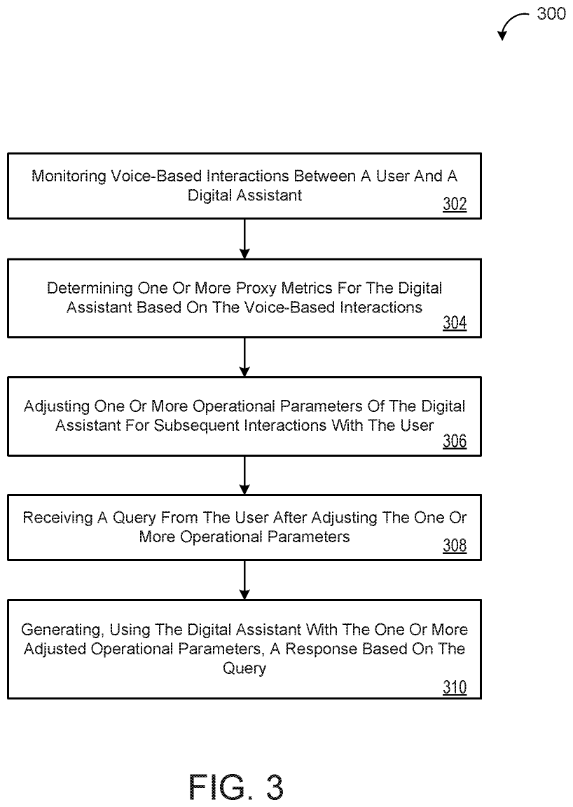

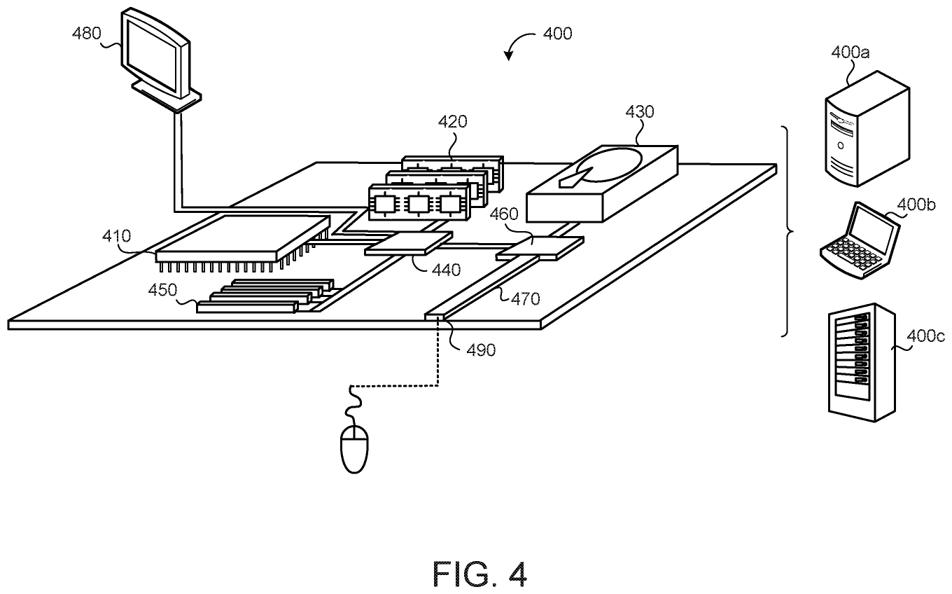

FIG. 3 includes a flowchart of an example arrangement of operations for a computer-implemented 300 of using proxy metrics 124 for speech personalization. The method 300 may execute on data processing hardware 410 (FIG. 4) using instructions stored on memory hardware 420 (FIG. 4) that may reside on the user device 110 and/or the remote system 120 of FIG. 1 each corresponding to a computing device 400 (FIG. 4).

At operation 302, the method 300 includes monitoring voice-based interactions 122 between a user 102 and a digital assistant 160. At operation 304, the method 300 includes determining one or more proxy metrics for the digital assistant based on the voice-based interactions. The one or more proxy metrics uniquely associated with the user, At operation 306, the method 300 includes adjusting one or more operational parameters 162 of the digital assistant 160 for subsequent interactions with the user 102. After adjusting the one or more operational parameters 162, the method 300 includes, at operation 308, receiving a query 106 from the user 102. At operation 310, the method 300 includes generating a response 165 based on the query 102 using the digital assistant 162 with the one or more adjusted operational parameters 132.

Thus, implementation herein personalize conversational digital assistants 160 by dynamically adapting operational parameters 162 based on user-specific interaction patterns (e.g., voice-based interactions 122), which achieves personalization without analyzing the semantic content or transcriptions of the speech input by the user 102.

Unlike conventional systems that rely on static configurations optimized for an average user 102, implementations herein monitor the voice-based interactions 122 to derive user-specific proxy metrics 124 reflecting individual conversational styles, such as interaction timing, pause durations, barge-in frequency and timing, and estimated speech rate. The proxy metrics 124, capturing behavioral aspects rather than linguistic content, serve as indicators of user preferences or state (e.g., patience, urgency) and form the basis for subsequent adjustments, thereby enhancing user privacy and reducing computational overhead associated with transcription analysis for personalization purposes.

Moreover, implementations herein utilize the proxy metrics 124 to adjust specific operational parameters 162 governing the interaction flow of the digital assistant 160 for future interactions with that particular user 102. Key parameters subject to adjustment include automatic speech recognition (ASR) endpointing thresholds (influencing responsiveness and turn-taking sensitivity, potentially by adapting transitions between different ASR processing levels) and text-to-speech (TTS) characteristics, such as playback speed and verbosity level. For instance, frequent early barge-ins (indicated by a short barge-in timing metric) may trigger an increase in TTS speed or a decrease in response verbosity, while patterns suggesting premature endpointing leads to adjustments allowing for longer user pauses. This mechanism allows the digital assistant 160 to tailor its responsiveness and output style to individual user 102 needs and preferences, moving beyond one-size-fits-all configurations to provide a more natural, efficient, and satisfying user experience.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 (e.g., the data processing hardware 113 of the user device 110 or the data processing hardware 122 of the remote system 120) can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory (e.g., the memory hardware 114 of the user device 110 or the memory hardware 124 of the remote system 120) 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
monitoring voice-based interactions between a user and a digital assistant;
determining, based on the voice-based interactions, one or more proxy metrics for the digital assistant, the one or more proxy metrics uniquely associated with the user,
adjusting, based on the one or more proxy metrics, one or more operational parameters of the digital assistant for subsequent interactions with the user;
after adjusting the one or more operational parameters, receiving a query from the user; and
generating, using the digital assistant with the one or more adjusted operational parameters, a response based on the query.

2. The method of claim 1, wherein:
adjusting the one or more operational parameters comprises selecting a pre-defined operational configuration from a plurality of pre-defined operational configurations of the digital assistant; and
each respective pre-defined operational configuration specifies corresponding values for the one or more operational parameters.

3. The method of claim 1, wherein determining the one or more proxy metrics comprises determining the one or more proxy metrics without analyzing transcriptions derived from user speech from the voice-based interactions.

4. The method of claim 1, wherein monitoring the voice-based interactions comprises receiving user feedback associated with interaction pacing of the digital assistant or interruptions by the digital assistant.

5. The method of claim 1, wherein:
adjusting the one or more operational parameters comprises modifying an endpointing parameter of the digital assistant for the user based on the one or more proxy metrics; and
the endpointing parameter influences when the digital assistant transitions from a first level of automatic speech recognition (ASR) processing to a second level of ASR processing.

6. The method of claim 5, wherein the one or more proxy metrics comprise a barge-in timing metric indicating a time duration between an initiation of a text-to-speech (TTS) output by the digital assistant and a subsequent user input detected during the TTS output.

7. The method of claim 5, wherein the one or more proxy metrics comprise a speech rate metric indicating an estimated rate of speech of the user during the voice-based interactions.

8. The method of claim 1, wherein adjusting the one or more operational parameters comprises modifying a text-to-speech (TTS) operational parameter of the digital assistant for the users based on the one or more proxy metrics.

9. The method of claim 8, wherein the TTS operational parameter comprises a TTS playback speed influencing a rate of speed that the digital assistant outputs the TTS output.

10. The method of claim 8, wherein the TTS operational parameter comprises a verbosity level influencing a length or level of detail of the TTS output.

11. A system comprising:
data processing hardware; and
memory hardware in communication with the data processing hardware, the memory hardware storing instructions that when executed on the data processing hardware cause the data processing hardware to perform operations comprising:
monitoring voice-based interactions between a user and a digital assistant;
determining, based on the voice-based interactions, one or more proxy metrics for the digital assistant, the one or more proxy metrics uniquely associated with the user;
adjusting, based on the one or more proxy metrics, one or more operational parameters of the digital assistant for subsequent interactions with the user;
after adjusting the one or more operational parameters, receiving a query from the user; and
generating, using the digital assistant with the one or more adjusted operational parameters, a response based on the query.

12. The system of claim 11, wherein:
adjusting the one or more operational parameters comprises selecting a pre-defined operational configuration from a plurality of pre-defined operational configurations of the digital assistant; and
each respective pre-defined operational configuration specifies corresponding values for the one or more operational parameters.

13. The system of claim 11, wherein determining the one or more proxy metrics comprises determining the one or more proxy metrics without analyzing transcriptions derived from user speech from the voice-based interactions.

14. The system of claim 11, wherein monitoring the voice-based interactions comprises receiving user feedback associated with interaction pacing of the digital assistant or interruptions by the digital assistant.

15. The system of claim 11, wherein:
adjusting the one or more operational parameters comprises modifying an endpointing parameter of the digital assistant for the user based on the one or more proxy metrics; and
the endpointing parameter influences when the digital assistant transitions from a first level of automatic speech recognition (ASR) processing to a second level of ASR processing.

16. The system of claim 15, wherein the one or more proxy metrics comprise a barge-in timing metric indicating a time duration between an initiation of a text-to-speech (TTS) output by the digital assistant and a subsequent user input detected during the TTS output.

17. The system of claim 15, wherein the one or more proxy metrics comprise a speech rate metric indicating an estimated rate of speech of the user during the voice-based interactions.

18. The system of claim 11, wherein adjusting the one or more operational parameters comprises modifying a text-to-speech (TTS) operational parameter of the digital assistant for the users based on the one or more proxy metrics.

19. The system of claim 18, wherein the TTS operational parameter comprises a TTS playback speed influencing a rate of speed that the digital assistant outputs the TTS output.

20. The system of claim 18, wherein the TTS operational parameter comprises a verbosity level influencing a length or level of detail of the TTS output.
